(19) United States
(12) Patent Application Publication
(10) Pub. No.: US 2014/0354642 A1
(43) Pub. Date: Dec. 4, 2014

(54) Visualization of 3D Medical Perfusion Images

(71) Applicant: KONINKLIJKE PHILIPS N.V., EINDHOVEN (NL)

(72) Inventors: Rafael Wiemker, Kisdorf (DE); Thomas Buelow, Grosshansdorf (DE); Martin Bergtholdt, Hamburg (DE); Kirsten Regina Meetz, Hamburg (DE); Ingwer-Curt Carlsen, Hamburg (DE)

(21) Appl. No.: 14/362,232

(22) PCT Filed: Nov. 15, 2012
(86) PCT No.: PCT/IB2012/056448

§ 371 Date: Jun. 2, 2014

Related U.S. Application Data
(60) Provisional application No. 61/567,696, filed on Dec. 7, 2011.

(51) Int. Cl. G06T 19/20; G06T 7/00; G06T 15/20

(52) U.S. Cl. CPC G06T 19/20; G06T 15/205; G06T 7/0016; G06T 2207/10096; G06T 2207/20221; G06T 2207/30068
USPC 345/424

(57) ABSTRACT

Image processing apparatus 110 comprising a processor 120 for combining a time-series of three-dimensional [3D] images into a single 3D image using an encoding function, the encoding function being arranged for encoding, in voxels of the single 3D image, a change over time in respective co-located voxels of the time-series of 3D images, an input 130 for obtaining a first and second time-series of 3D images 132 for generating, using the processor, a respective first and second 3D image 122, and a renderer 140 for rendering, from a common viewpoint 154, the first and the second 3D image 122 in an output image 162 for enabling comparative display of the change over time of the first and the second time-series of 3D images.

### FIELD OF THE INVENTION

The invention relates to an image processing apparatus and a method of combining a series of images into a single image. The invention further relates to a workstation or imaging apparatus comprising the image processing apparatus set forth, and to a computer program product for causing a processor system to perform the method set forth.

In the fields of image viewing and image display, it may be desirable to combine several images into a single output image to enable convenient display of relevant information comprised within the several images to a user. A reason for this is that the user may otherwise need to scroll through, or visually compare, the several images to obtain said information. By combining the several images in the single output image, the user may obtain said information of the several images by only viewing the single output image.

### BACKGROUND OF THE INVENTION

A user may need to obtain visual information from a time-series of three-dimensional [3D] images. In particular, the user may need to compare a first time-series of 3D images to a second time-series of 3D images to obtain said information.

For example, in the field of breast cancer treatment, a patient may undergo chemo or radiation therapy for treating a malignant growth in breast tissue. Before starting treatment, a first time-series of 3D images may be acquired as part of a so-termed baseline exam, e.g., using Magnetic Resonance Imaging (MRI). During or after the treatment, a second time-series of 3D images may then be acquired as part of a so-termed follow-up exam for establishing whether the patient responds to the chemo or radiation therapy.

Each time-series of 3D images may be a so-termed Dynamic Contrast Enhanced (DCE) time-series, in which 3D images are acquired pre- and post-administration of a contrast agent to the patient for enabling a clinician to evaluate perfusion in or near the breast tissue. Each time-series may span, e.g., several minutes. By comparing said perfusion before and after treatment, the clinician may obtain relevant information which allows establishing whether the patient responds to the chemo or radiation therapy.

It is known to combine a time-series of 3D images into a single 3D image. For example, a publication titled “Methodology for visualization and perfusion analysis of 4D dynamic contrast-enhanced CT imaging” by W. Wee et al., Proceedings of the XVIth ICCR, describes a method of segmenting vasculature and perfused tissue from four-dimensional (4D) perfusion Computed Tomography (pCT) scans containing other anatomical structures. The method involves observing the intensity change over time for a given voxel within the 4D pCT data set in order to create 3D functional parameter maps of perfused tissue. In these maps, a magnitude of the following is indicated: best fit of intensity-time curves, difference between the maximum and minimum intensities, and time to reach the maximum intensity.

A problem of the aforementioned method is that it insufficiently suitable for intuitively displaying a first and second time-series of 3D images to a user.

### SUMMARY OF THE INVENTION

It would be advantageous to have an improved apparatus or method for intuitively displaying a first and second time-series of 3D images to a user.

To better address this concern, a first aspect of the invention provides an image processing apparatus comprising a processor for combining a time-series of three-dimensional [3D] images into a single 3D image, using an encoding function, the encoding function being arranged for encoding, in voxels of the single 3D image, a change over time in respective co-located voxels of the time-series of 3D images, an input for obtaining a first and second time-series of 3D images for generating, using the processor, a respective first and second 3D image, and a renderer for rendering, from a common viewpoint, the first and the second 3D image in an output image for enabling comparative display of the change over time of the first and the second time-series of 3D images.

In a further aspect of the invention, a workstation and an imaging apparatus are provided comprising the image processing apparatus set forth.

In a further aspect of the invention, a method is provided comprising using a processor for combining a time-series of 3D images into a single 3D image, using an encoding function, the encoding function being arranged for encoding, in voxels of the single 3D image, a change over time in respective co-located voxels of the time-series of 3D images, obtaining a first and second time-series of 3D images for generating, using the processor, a respective first and second 3D image, and rendering, from a common viewpoint, the first and the second 3D image in an output image for enabling comparative display of the change over time of the first and the second time-series of 3D images.

In a further aspect of the invention, a computer program product is provided comprising instructions for causing a processor system to perform the method set forth.

The processor is arranged for combining a time-series of 3D images into a single 3D image. Here, the term 3D image refers to a volumetric image, e.g., comprised of volumetric image elements, i.e., so-termed voxels, or to a 3D image that may be interpreted as a volumetric image, e.g., a stack of 2D slices comprised of pixels which together constitute, or may be interpreted as, a volumetric image. For combining said time-series of 3D images into the single 3D image, an encoding function is used. The encoding function expresses how a change over time, occurring for a given voxel in each of the time-series of 3D images, is to be expressed in a co-located voxel in the single 3D image. Thus, the change in value over time at a given spatial position in the time-series of 3D images is expressed as a value at the same spatial position in the single 3D image.

The input obtains a first time-series of 3D images and a second time-series of 3D images. The processor is then used to generate, from the first time-series of 3D images, a first 3D image. Thus, the processor combines the first time-series of 3D images into the first 3D image. Furthermore, the processor is used to combine the second time-series of 3D images into a second 3D image. The renderer then performs a volume rendering of the first 3D image and of the second 3D image. As a result, an output image is obtained comprising a volume rendering of both 3D images. The volume rendering of both 3D images is from the same viewpoint, i.e., involving a virtual camera being positioned at the same position. Hence, the same portion of the first and the second 3D image is shown in the output image.

As a result, an output image is obtained that, due to it comprising the volume rendering of both 3D images from the same viewpoint, provides a comparative display of the change of the change over time of the first and the second time-series of 3D images. Thus, a user can directly determine a difference between the change over time of the first time-series of 3D images and the second time-series of 3D images by viewing the output image.

The invention is partially based on the recognition that it is confusing for a user to obtain relevant information from several time-series of 3D images due to the sheer amount of visual information constituted by said time-series of 3D images. However, the inventors have recognized that the information that is of relevance to the user typically relates to the difference between the changes over time in each of the time-series of 3D images rather than, e.g., the change over time itself in each of said time-series of 3D images.

By combining the first time-series of 3D images into a first 3D image and combining the second time-series of 3D images into a second 3D image, the change over time of each time-series is visualized in two respective single 3D images. By rendering both of the single 3D images into an output image, and by using a common viewpoint in the rendering, a single output image is obtained that shows the changes over time of each time-series simultaneously and from a common viewpoint. The user can thus easily obtain the differences between the changes over time by viewing the single output image.

Advantageously, the user may more easily discern relevant information contained in the first and second time-series of 3D images. Advantageously, visually inspecting or comparing the first and second time-series of 3D images takes less time.

Optionally, the processor is arranged for using a further encoding function, the further encoding function differing from the encoding function for differently encoding said change over time in respective co-located voxels of the time-series of 3D images, and the processor is arranged for generating, using the encoding function, a first intermediate 3D image from the first time-series of 3D images and a second intermediate 3D image from the second time-series of 3D images, and for generating, using the further encoding function, a third intermediate 3D image from the first time-series of 3D images and a fourth intermediate 3D image from the second time-series of 3D images, and for generating the first and the second 3D image in dependence on the first intermediate 3D image, the second intermediate 3D image, the third intermediate 3D image and the fourth intermediate 3D image.

The processor uses the further encoding function to encode a different aspect of the change over time in respective co-located voxels of the time-series of 3D images. For example, the encoding function may encode a rate of the change over time, and the further encoding function may encode a magnitude of the change over time. The encoding function and the further encoding function are used to generate, from the first time-series of 3D images, a respective first and third intermediate 3D image, and from the second time-series of 3D images, a respective second and fourth intermediate 3D image. Therefore, for each of the time-series of 3D images, two intermediate 3D images are obtained representing different encodings of the change over time in each of the time-series of 3D images. All four intermediate 3D images are then used in the generation of the first and the second 3D image, which are subsequently rendered, from a common viewpoint, in an output image.

As a result, an output image is obtained that enables comparative display of two different aspects of the change over time of the first and the second time-series of 3D images. For example, the user may obtain the differences between the rate and magnitude of the changes over time by viewing the single output image. Advantageously, by using the further encoding function in addition to the encoding function, a better representation of the differences between the changes over time in the first and the second time-series of 3D images is obtained in the output image. Advantageously, the encoding function and the further encoding function together more reliably encode said changes over time.

Optionally, the processor is arranged for (i) generating the first 3D image as a difference between the first intermediate 3D image and the second intermediate 3D image, and (ii) generating the second 3D image as the difference between the third intermediate 3D image and the fourth intermediate 3D image. The first 3D image thus directly shows the differences between a first aspect of the changes over time of the first and the second time-series of 3D images, and the second 3D image directly shows the differences between a second aspect of said changes over time. By rendering the above first and the second 3D image in the output image, the user may directly view said differences, without needing intermediate visual interpretation steps. Advantageously, the user may more easily discern relevant information contained in the first and second time-series of 3D images. Advantageously, visually inspecting said time-series of 3D images takes less time.

Optionally, the renderer is arranged for (i) using an image fusion process to combine the first and the second 3D image into a fused 3D image, and (ii) rendering the fused 3D image in the output image. By using an image fusion process to combine the first and the second 3D image into a fused 3D image, the first and the second 3D image are merged into a single 3D image which is then rendered in the output image. The relevant information can thus be obtained by the user from a single volume rendering. Advantageously, the user may more easily discern the differences between the changes over time of the first and the second time-series of 3D images, as the intermediate visual interpretation steps needed for comparing two volume renderings are omitted.

Optionally, the image fusion process comprises (i) mapping voxel values of the first 3D image to at least one of the group of: a hue, a saturation, an opacity of the voxel values of the fused 3D image, and (ii) mapping the voxel values of the second 3D image to at least another one out of said group. By mapping voxel values of the first 3D images to a portion or aspect of the voxel values of the fused 3D image, and by mapping the voxel values of the second 3D image to a different portion or aspect of the voxel values of the fused 3D image, the first and second 3D image are clearly distinguishable in the fused 3D image. Advantageously, the user can clearly distinguish in the output image between the information provided by the first 3D image and the information provided by the second 3D image.

Optionally, the processor is arranged for using a registration process for obtaining the first and the second 3D image as being mutually registered 3D images. By using a registration process, an improved fused 3D image is obtained, as differences in spatial position between the information provided by the first 3D image and the information provided by the second 3D are reduced or eliminated. Advantageously, the user may more easily perceive the differences between the changes over time of the first and the second time-series of 3D images in the output image, as the intermediate visual interpretation steps needed for compensating for differences in spatial position are omitted.

Optionally, the processor is arranged for evaluating a result of the registration process for, instead of rendering the fused 3D image in the output image, rendering the first and the second 3D image in separate viewports in the output image for obtaining a side-by-side rendering of the first and the second 3D image if the registration process fails.

If the registration process yields an unsatisfactory result, e.g., due to failure of the registration process itself or due to significant differences between the first and the second time-series of 3D images, the rendering of the fused 3D image is omitted, as an unsatisfactory registration result may yield an unsatisfactory fused 3D image and thus an unsatisfactory output image. Instead, the first and the second 3D images are each rendered individually, and the resulting two volume renderings are displayed side-by-side in the output image. Here, the term viewport refers to a portion of the output image used for displaying the volume rendering. Advantageously, the user is less likely to draw erroneous conclusions from the output image in case the registration process yields an unsatisfactory result. Advantageously, the user may more easily discern a cause of the unsatisfactory result.

Optionally, the processor is arranged for (i) generating the first 3D image as a combination of the first intermediate 3D image and the third intermediate 3D image, and (ii) generating the second 3D image as the combination of the second intermediate 3D image and the fourth intermediate 3D image. The first 3D image thus combines both aspects of the changes over time of the first time-series of 3D images, and the second 3D image combines both aspects of the changes over time of the second time-series of 3D images. By rendering the above first and the second 3D image in the output image, the user may obtain the relevant information of the first time-series of 3D images separate from that of the second time-series of 3D images. Advantageously, the user is less confused by the output image if the first and second time-series of 3D images are different in nature, e.g., being of a different subject.

Optionally, the processor is arranged for using an image fusion process for said generating of the first 3D image and/or said generating of the second 3D image. An image processing process is well suited for combining the first intermediate 3D image and the third intermediate 3D image into the first 3D image, and combining the second intermediate 3D image and the fourth intermediate 3D image into the second 3D image.

Optionally, the renderer is arranged for (i) rendering the first 3D image in a first viewport in the output image, and (ii) rendering the second 3D image in a second viewport in the output image, for obtaining a side-by-side rendering of the first and the second 3D image. The first 3D image is rendered as a first volume rendering in a first viewport in the output image, i.e., in a first portion of the output image that is provided for viewing the first 3D image, and the second 3D image is rendered as a second volume rendering in a second viewport in the output image, e.g., in a second, and thus separate, portion of the output image. Thus, the first 3D image and the second 3D image are visualized separately in the output image. Advantageously, the user can easily distinguish between the information provided by the first and the second time-series of 3D images in the output image, resulting in less confusion if both time-series of 3D images are, e.g., different in nature, being of a different subject or subject to an erroneous selection.

Optionally, the image processing apparatus further comprises a user input for enabling a user to modify the common viewpoint of the rendering. The user can thus interactively view the first and the second 3D image by modifying the viewpoint used in the rendering. Advantageously, the user may simultaneously navigate through both 3D images, while, during the navigation, still obtaining a comparative display of the change over time of the first and the second time-series of 3D images in the output image.

Optionally, the first time-series of 3D images constitutes a baseline exam of a patient showing perfusion of an organ and/or tissue of the patient at a baseline date, and the second time-series of 3D images constitutes a follow-up exam of the patient showing the perfusion of the organ and/or tissue of the patient at a follow-up date for enabling the comparative display of the perfusion at the baseline date and the follow-up date. The term perfusion refers to the change over time in blood flow or other fluid flow within each of the time-series of images over a relatively short time period, e.g., seconds, minutes, hours, i.e., within a single exam of the patient. The image processing apparatus enables comparative display of the perfusion at the baseline date and the follow-up date. Effectively, said comparative display provides a display of the change in perfusion over time, i.e., the change between the baseline date and the follow-up date. For clarity reasons, it is noted, however, that the term change over time is otherwise used as referring to the changes within each of the time-series of 3D images, e.g., to the perfusion and not to the change in perfusion.

It will be appreciated by those skilled in the art that two or more of the above-mentioned embodiments, implementations, and/or aspects of the invention may be combined in any way deemed useful.

Modifications and variations of the workstation, the imaging apparatus, the method, and/or the computer program product, which correspond to the described modifications and variations of the image processing apparatus, can be carried out by a person skilled in the art on the basis of the present description.

A person skilled in the art will appreciate that the method may be applied to multi-dimensional image data, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM). A dimension of the multi-dimensional image data may relate to time. For example, a three-dimensional image may comprise a time domain series of two-dimensional images.

The invention is defined in the independent claims. Advantageous embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows an image processing apparatus according to the present invention and a display connected to the image processing apparatus;

FIG. 2a shows a 3D image from a first time-series of 3D images;

FIG. 2b shows a further 3D image from a second time-series of 3D images;

FIG. 3 shows the first time-series of 3D images, and a first and a third intermediate 3D image being obtained from said time-series of 3D images;

FIG. 4 shows the first and the third intermediate 3D images and a second and a fourth intermediate 3D image being combined and rendered in an output image;

FIG. 5a shows a difference between the first and the second intermediate 3D images and a difference between the third and the fourth intermediate 3D images being fused in a fused image, and the fused image being rendered in the output image;

FIG. 5b shows a combination of the first and the third intermediate 3D images and a combination of the second and the fourth intermediate 3D images being rendered in separate viewports in the output image;

FIG. 6a shows an output image comprising rendering of a fused image;

FIG. 6b shows an output image comprising renderings into separate viewports;

FIG. 7 shows a method according to the present invention; and

FIG. 8 shows a computer program product according to the present invention.

### DETAILED DESCRIPTION OF EMBODIMENTS

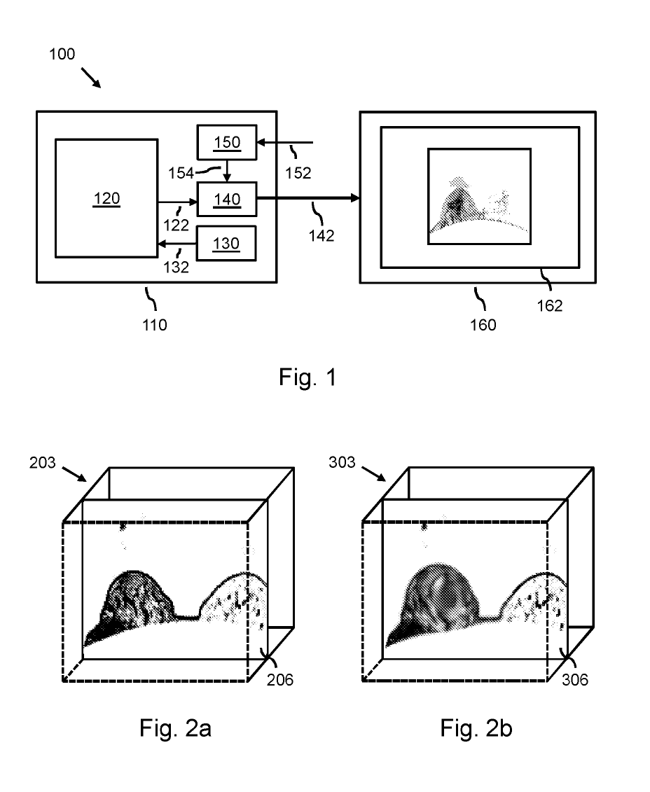

FIG. 1 shows an image processing apparatus 110, henceforth referred to as apparatus 110. The apparatus 110 comprises a processor 120 for combining a time-series of 3D images into a single 3D image, using an encoding function. The apparatus further comprises an input 130 for obtaining a first and a second time-series of 3D images 132 in order to generate, using the processor 120, a respective first and second 3D image 122. For providing the first and the second time-series of 3D images 132 to the processor 120, the input 130 is shown to be connected to the processor 120. The apparatus 110 further comprises a renderer 140 for rendering, from a common viewpoint, the first and the second 3D image 122 in an output image 162. For displaying the output image 162 to a user, the apparatus 110 may be connected to a display 160 for providing display data 142 comprising, or being indicative of, the output image 162 to the display 160. The display 160 may be a part of the apparatus 110 or an external display, i.e., not part of the apparatus 110.

The apparatus 110 may further comprise a user input 150 for enabling a user to modify the common viewpoint 154 of the rendering. For that purpose, the user input 150 may be connected to user interface means (not shown in FIG. 1) such as a mouse, a keyboard, a touch sensitive device, etc, and receive user input data 152 from said user interface means.

During operation of the apparatus 110, the input 130 obtains the first and the second time-series of 3D images 132 and provides said time-series of 3D images 132 to the processor 120. The processor 120 generates the first and the second 3D image 122, using an encoding function, the encoding function being arranged for encoding, in voxels of a single 3D image, a change over time in respective co-located voxels of the time-series of 3D images. The processor 120 provides the first and the second 3D image 122 to the renderer 140. The renderer 140 renders, from the common viewpoint 154, the first and the second 3D image 122 in the output image 162 for enabling comparative display of the change over time of the first and the second time-series of 3D images on the display 160.

It is noted that the term image refers to a multi-dimensional image, such as a two-dimensional (2D) image or a three-dimensional (3D) image. Here, the term 3D image refers to a volumetric image, i.e., having three spatial dimensions. The image is made up of image elements. The image elements may be so-termed picture elements, i.e., pixels, when the image is a 2D image. The image elements may also be so-termed volumetric picture elements, i.e., voxels, when the image is a volumetric image. The term value in reference to an image element refers to a displayable property that is assigned to the image element. For example, a value of a voxel may represent a luminance and/or chrominance of the voxel, or may indicate an opacity or translucency of the voxel within the volumetric image.

The term rendering, in reference to a 3D image, refers to using a volumetric rendering technique to obtain an output image from the volumetric image. The output image may be a 2D image. The output image may also be an image that provides stereoscopy to a user. The volumetric rendering technique may be any suitable technique from the field of volume rendering. For example, a so-termed direct volume rendering technique may be used, typically involving casting of rays through the voxels of the 3D image. Other examples of techniques which may be used are maximum intensity projection or surface rendering.

FIG. 2a shows a 3D image 203 from a first time-series of 3D images 200. The 3D image 203 is shown, by way of example, to be a medical 3D image having been acquired by a Magnetic Resonance (MR) imaging technique. However, the 3D image 203, and in general all of the 3D images, may have been acquired by another imaging technique, or may rather be from a different, i.e., non-medical, field. The 3D image 203 is shown partially translucent for showing a contents 206 of the 3D image 203. FIG. 2b shows a further 3D image from a second time-series of 3D images. The further 3D image 303 is also shown partially translucent for showing the contents 306 of the further 3D image 303. When comparing FIGS. 2a and 2b, differences between the contents of both 3D images 203, 303 are visible. The differences may be due to the first time-series of 3D images constituting a baseline exam of a patient for visualizing a medical property of the patient, and the second time-series of 3D images constituting a follow-up exam of the patient for visualizing a change in said medical property. The medical property may relate to a malignant growth, e.g., its size or location. The change may be a change in size, e.g., due to further growth over time, or rather a reduction in size due to the patient responding to therapy.

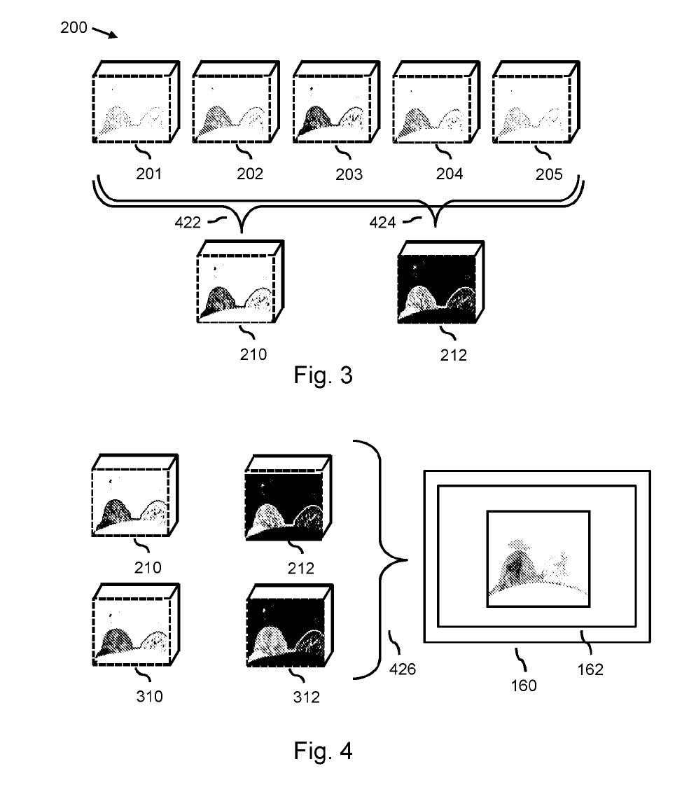

FIG. 3 shows the first time-series of 3D images 200 comprising, by way of example, five 3D images 201-205. The first time-series of 3D images 200 may be a so-termed Dynamic Contrast Enhanced (DCE) MRI scan, which may be acquired before starting treatment of a patient. Although not shown in FIG. 3, a further DCE MRI scan may have been acquired after a certain treatment interval in order to establish whether the patient responds to therapy. The further DCE MRI scan may constitute a second time-series of 3D images, which may be similar to the first time-series of 3D images 200 except for its contents. Of course, the first and the second time-series of 3D images may also be from a different field, e.g., constitute two time-series of seismic 3D images for seismic monitoring of an area.

FIG. 3 further shows a result of the processor 120 being arranged for generating 422, using the encoding function, a first intermediate 3D image 210 from the first time-series of 3D images 200. Moreover, FIG. 3 shows a result of the processor 120 being arranged for using a further encoding function, with the further encoding function differing from the encoding function for differently encoding said change over time in respective co-located voxels of the time-series of 3D images 200, and the processor being arranged for generating 424, using the further encoding function, a third intermediate 3D image 212 from the first time-series of 3D images 200. For visually differentiating between 3D images generated using the encoding function and the further encoding function, the 3D images that have been generated using the further encoding functions are shown in inverted grayscales with respect to the 3D images that have been generated using the encoding function. It will be appreciated, however, that both types of 3D images may also look similar.

The encoding function and the further encoding function may be any suitable functions for translating a time curve for each voxel into a parameter or value for each voxel. Such encoding functions are known from various imaging domains. In general, such encoding functions may relate to determining a maximum, a minimum or a derivative of the time curve. In the field of medical imaging, such encoding functions may specifically relate to perfusion, i.e., to blood flow in or out of a vessel, a tissue, etc. Examples of perfusion-related encoding functions are so-termed Percentage Enhancement (PE) and Signal Enhancement Ratio (SER) functions for MRI-acquired 3D images, and Time To Peak (TTP), Mean Transit Time (MTT), Area Under the Curve (AUC) functions for CT-acquired 3D images. In the following, the encoding function is chosen, by way of example, as a PE encoding function for providing, as the first intermediate 3D image 210, an intermediate PE 3D image. Moreover, the further encoding function is chosen as a SRE encoding function for providing, as the third intermediate 3D image 212, an intermediate SRE 3D image.

FIG. 4 shows a result of the processor 120 being arranged for generating, using the encoding function, a second intermediate 3D image 310 from the second time-series of 3D images, and for generating, using the further encoding function, a fourth intermediate 3D image 312 from the second time-series of 3D images. Thus, an intermediate PE 3D image and an intermediate SRE is obtained for each of the two time-series of 3D images. Of relevance to the user may be the difference between both intermediate PE 3D images, as well as the difference between both intermediate SRE 3D images. For this reason, the processor 120 is arranged for, as is shown schematically in FIG. 4, generating 426 the first and the second 3D image in dependence on the first intermediate 3D image 210, the second intermediate 3D image 310, the third intermediate 3D image 212 and the fourth intermediate 3D image 312. Therefore, the renderer 140 may then render the first and the second 3D image in an output image 162 for enabling said comparative display of the change over time of the first and the second time-series of 3D images on the display 160.

There may be various ways for generating the first and the second 3D image in dependence on said intermediate 3D images, as well as for subsequently rendering, from a common viewpoint, the first and the second 3D images in the output image.

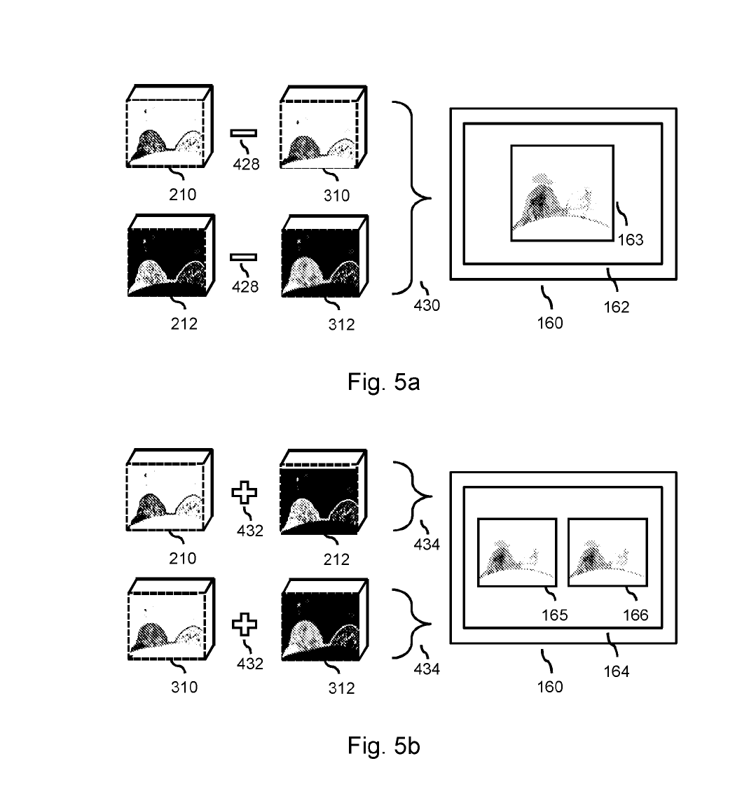

FIG. 5a shows a first example, wherein the processor 120 is arranged for (i) generating the first 3D image as a difference 428 between the first intermediate 3D image 210 and the second intermediate 3D image 310, and for generating the second 3D image as the difference 428 between the third intermediate 3D image 212 and the fourth intermediate 3D image 312. The difference 428 is indicated schematically in FIG. 5a by a minus sign. Generating the first 3D image may comprise simply subtracting the second intermediate 3D image 310 from the first intermediate 3D image 210. As a result, the voxels of the first 3D image comprise signed values, i.e., both positive and negative values. Generating the second 3D image may also involve said subtracting. Alternatively, determining the difference 428 may involve usage of a non-linear function, e.g., for emphasizing large differences between both intermediate 3D images, and for deemphasizing small differences. Of course, the difference 428 may also be determined in various other suitable ways.

The processor 120 may be arranged for using a registration process for obtaining the first and the second 3D image 122 as being mutually registered 3D images. Said use of the registration process may comprise using a spatial registration between the first time-series of 3D images and the second time-series of 3D images. Then, using a result of the registration, for each corresponding voxel pair between the intermediate PE 3D images, a change, i.e., difference, in PE value is computed, and for each corresponding voxel pair between the intermediate SRE 3D images, a change in SRE value is computed.

In the example of FIG. 5a, the renderer 140 may be arranged for using an image fusion process 430 to combine the first and the second 3D image into a fused 3D image, and for rendering the fused 3D image in the output image 162. Thus, the image fusion process 430 generates the fused 3D image, using the first and the second 3D image. The image fusion process 430 may be, e.g., a single process or a combination of the following.

A first image fusion process comprises color-coding the change in PE value in the voxels of the fused 3D image, e.g., with a red color for PE increases and a green color for PE decreases, and modulating the opacity of voxels in the fused 3D image by the PE increase. A second image fusion process comprises modulating the opacity of voxels in the fused 3D image by a maximum PE value of the voxel in both intermediate PE 3D images and color-coding the change in SER value in the voxels of the fused 3D image, e.g., with a red hue for SER increases and a green hue for PE decreases, and a color saturation given by a magnitude of the SER in SER value, e.g., yielding white for areas having a high PE value but insignificant change in SER value. A third image fusion process comprises using a 2D Look-Up Table (LUT) to assign colors and opacities to the voxels of the fused 3D image as a function of positive and negative changes in PE and SER values. The 2D LUT may be manually designed such as to most intuitively reflect the medical knowledge of the user.

In general, the image fusion process may comprises mapping voxel values of the first 3D image to at least one of the group of: a hue, a saturation, an opacity of the voxel values of the fused 3D image, and mapping the voxel values of the second 3D image to at least another one out of said group. The aforementioned image fusion processes may, of course, also apply to fusing the difference between the first and the third intermediate 3D images with the difference between the third and the fourth intermediate 3D image, i.e., said intermediate 3D images do not need to be intermediate PE or SRE 3D images.

The example shown in FIG. 5a is referred to as Direct Change Visualization, as after spatial registration, a change of one of the perfusion parameters is computed for each voxel. Then, a single 3D rendering is computed by casting viewing rays through all voxels and deriving the color as a function of the change sign, i.e., whether the change is positive or negative in the selected perfusion parameter, and the opacity from the amount of change. Although not shown in FIG. 5a, the processor 120 may be arranged for evaluating a result of the registration process for, instead of rendering the fused 3D image in the output image 162, rendering the first and the second 3D image in separate viewports in the output image for obtaining a side-by-side rendering of the first and the second 3D image if the registration process fails. The side-by-side rendering constitutes another way, i.e., a further example, of generating the first and the second 3D image in dependence on the intermediate 3D images, and of subsequently rendering, from a common viewpoint, the first and the second 3D images in the output image. Said side-by-side rendering will be further explained in reference to FIG. 5b.

FIG. 5b shows a result of the processor 120 being arranged for generating the first 3D image as a combination 432 of the first intermediate 3D image 210 and the third intermediate 3D image 212, and for generating the second 3D image as the combination 432 of the second intermediate 3D image 310 and the fourth intermediate 3D image 312. Moreover, the renderer 140 is arranged for rendering the first 3D image in a first viewport 165 in the output image 164, and rendering the second 3D image in a second viewport 166 in the output image, for obtaining a side-by-side rendering of the first and the second 3D image providing a comparative display of the change over time of the first and second time-series of 3D images.

The processor 120 may be further arranged for, as is shown schematically in FIG. 5b, using an image fusion process 434 for generating the first 3D image from the combination 432 of the first 210 and the third 212 intermediate 3D images, and for generating the second 3D image from the combination 432 of the second 310 and the fourth 312 intermediate 3D images. The image fusion process 434 may be any of image fusion processes previously discussed in relation to FIG. 5a. In particular, when one of the intermediate 3D images in the combination is an intermediate PE 3D image and the other is an intermediate SRE 3D image, the PE value may be used to modulate the opacity of a voxel in the fused 3D image, and the SER value may be used to modulate the color. As a result, the first and the second 3D images are obtained as being first and second fused 3D images.

The first and the second 3D images may be referred to as kinetic 3D images, in that they represent the change over time of the first and second time-series of 3D images. Both kinetic 3D images may be further fused or overlaid over one of the 3D images of respective time-series of 3D images for improving spatial orientation of a user viewing the output image 164. For example, the first fused 3D image may be overlaid over one of the 3D images of the first time-series of 3D images. As a result, the luminance of a voxel in the first fused 3D image may be predominantly provided by one of the 3D images of the first time-series of 3D images, the color may be modulated by the SER value, and the opacity of the voxel may be modulated by the PE value. Alternatively, the kinetic 3D images may be overlaid over a standard or reference 3D image, as obtained from, e.g., a medical atlas.

A spatial registration may be computed between the first and second time-series of 3D images. As discussed in reference to FIG. 5a, the renderer may be arranged for rendering the first and the second 3D image in separate viewports 165, 166 in the output image 164 for obtaining a side-by-side rendering of the first and the second 3D image if the registration process fails, and otherwise for generating the output image as discussed in reference to FIG. 5a, i.e., by means of the aforementioned Direct Change Visualization. Alternatively, the processor 120 and the renderer 140 may also be arranged for generating the output image 164 as a side-by-side rendering even if the registration process succeeds.

The example shown in FIG. 5a is referred to as Side-By-Side Visualization. In contrast to Direct Change Visualization, the first and second time-series of 3D images each yield a separate volume rendering in the output image 160 of their changes over time. However, as in the Direct Change Visualization, the separate volume renderings show the first and the second 3D image from a common viewpoint. The user may interactively modify the common viewpoint of the rendering, e.g., using a user interface means that is connected to the user input 150. As a result, a rotation, shift, etc of one of the volume renderings results in a same rotation, shift, etc, of the other volume rendering. Thus, a comparative display of the change over time of the first and second time-series of 3D images is maintained.

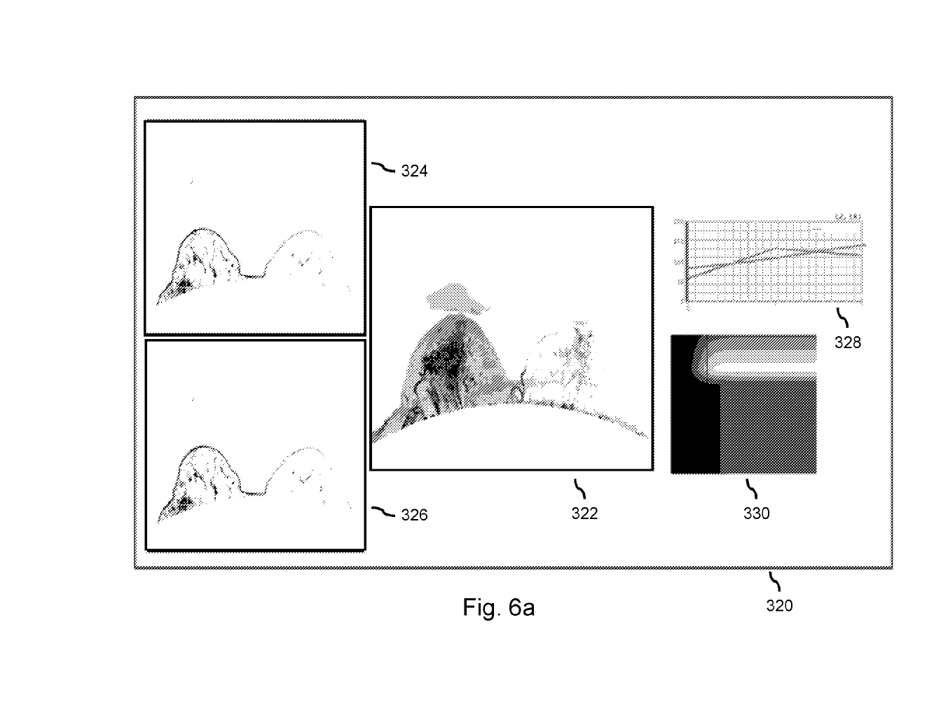

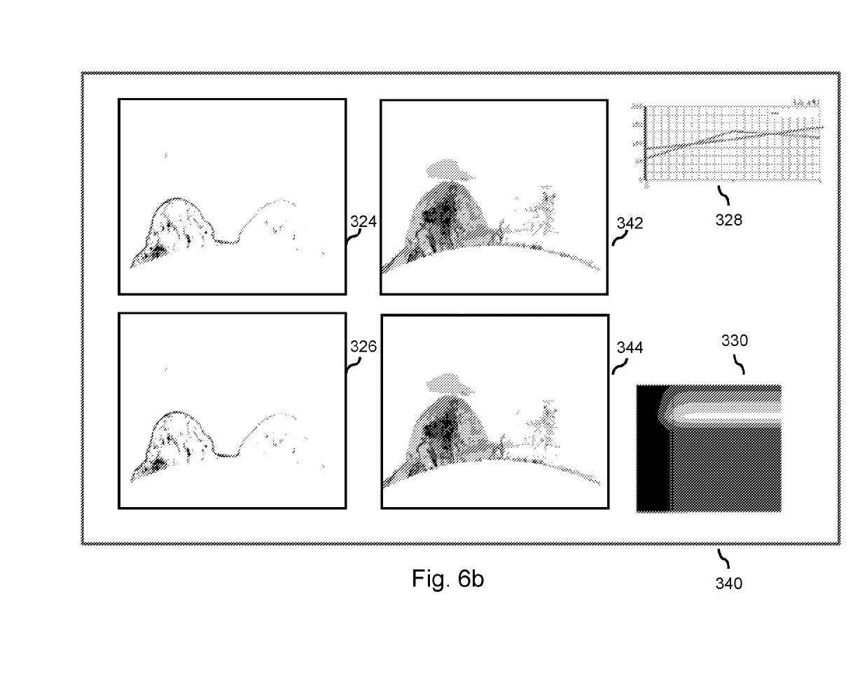

FIG. 6a shows an example of an output image 320 comprising a main viewport 322 comprising a Direct Change Visualization of the first and second time-series of 3D images, i.e., the main viewport 322 shows a volume rendering of a fused 3D image as discussed in relation to FIG. 5a. The user input 150 may be arranged for receiving a selection command from the user, indicative of the user clicking on or selecting a location in the volume rendering of the fused 3D image, i.e., in the main viewport 322. As a result, the renderer 140 may display a slice-wise view of the corresponding locations of each of the first and the second time-series of 3D images in a first auxiliary viewport 324 and in a second auxiliary viewport 326, respectively. Moreover, the renderer may display, in response to the selection command, kinetic curves for the corresponding locations of each of the first and the second time-series of 3D images in the output image 320. Said display may be in a kinetic viewport 328. Here, the term kinetic curve refers to a plot of the change in value over time for a particular voxel across the respective time-series of 3D images. Lastly, the renderer 140 may be arranged for displaying a visualization legend 330, showing how the change over time of the first and second time-series of 3D images is visualized in the main viewport 322. The visualization legend 330 may, in case the image fusion process uses a 2D LUT, visualize the contents of the 2D LUT as a 2D image of varying color, intensity, opacity, etc.

FIG. 6b shows an example of an output image 340 comprising a first main viewport 342 comprising a volume rendering of the first 3D image and a second main viewport 344 comprising a volume rendering of the second 3D image. The first and second main viewports 342, 344 together provide the side-by-side visualization of the change over time of the first and second time-series of 3D images, i.e., the first and second main viewports 342, 344 show separate volume renderings of the first and the second 3D images as discussed in relation to FIG. 5b. Moreover, the output image 340 comprises the first auxiliary viewport 324, the second auxiliary viewport 326, the kinetic viewport 328 and the visualization legend 330, as previously discussed in relation to FIG. 6a.

The first and second main viewports 342, 344 and the first and second auxiliary viewports 324, 326 may be coupled such that the slice-wise view of the second time-series of 3D images in the second auxiliary viewport 326 is warped as a curvilinear reformat to match the slice-wise view of the first time-series of 3D images in the first auxiliary viewport 324. Moreover, a curvilinear reformat of the second time-series of 3D images in the second auxiliary viewport 326 is computed to reflect the slice thickness of the first time-series of 3D images in the first auxiliary viewport 324, and the kinetic volume rendering of the second time-series of 3D images in the second main viewport 344 is warped to match the kinetic volume rendering of the first time-series of 3D images in the first main viewport 342. Moreover, the main 342, 344 and auxiliary 324, 326 viewports may be coupled by means of the processor 120 and the renderer 140 being arranged such that an interactive rotation of one of the kinetic volume renderings results in a same rotation of the other kinetic volume rendering, an interactive selection of a different slice in one of the slice-wise views selects a same slice in the other slice-wise view, and a click or selection of the user into either one of the two kinetic volume renderings selects and displays the appropriate slice-wise view of the corresponding location in both of the auxiliary viewports 324, 326 and displays the appropriate kinetic curves in the kinetic viewport 328. Moreover, an interactive change of the color and/or opacity modulation in one of the main viewports 324, 344 changes the color and/or opacity modulation in the other main viewport 324, 344 in a same way.

Alternatively, the aforementioned viewports may be coupled as previously discussed, but the kinetic volume rendering of the second time-series of 3D images in the second main viewport 344 may not be warped. Instead, a click or selection into the kinetic volume rendering may select a corresponding location for the corresponding slice-wise view in the second auxiliary viewport 326 and the kinetic viewport 328, but without the slice-wise views and the kinetic volume renderings being warped as previously discussed.

It is noted that, in general, a single 3D image may be referred to simply as a 3D image, whereas a time-series of 3D images, e.g., a perfusion volume dataset, may be referred to as a 4D image. Hence, the volume renderings in the first and second main viewports 342, 344 of FIG. 6b may be referred to as volume renderings of 4D images. Moreover, a combination of two or more time-series of 3D images, e.g., a baseline and follow-up exam of perfusion volumes, may be referred to as a 5D image. Hence, the volume rendering in the main viewport 322 in FIG. 6a may be referred to as a volume rendering of a 5D image. Moreover, the volume renderings in the first and second auxiliary viewports 324, 326 of FIG. 6b may be referred to as volume renderings of 3D images, as they comprise slice-wise views, i.e., 2D image slices and additionally color-encoded information of the change over time in each of the corresponding time-series of 3D images, i.e., kinetic information.

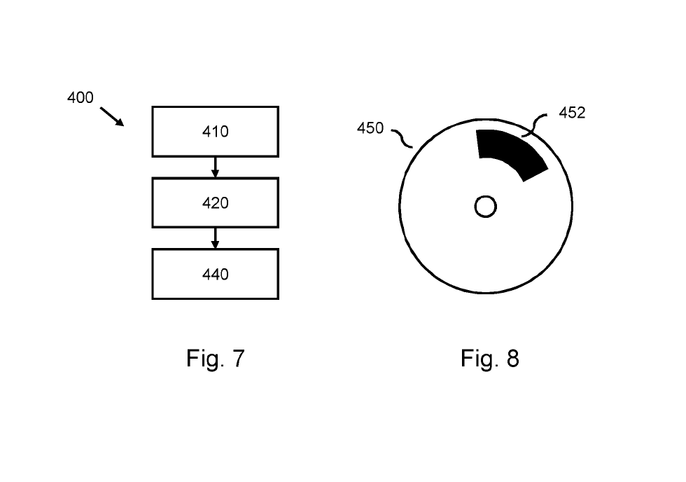

FIG. 7 shows a method 400 according to the present invention, comprising, in a first step titled “USING A PROCESSOR”, using 410 a processor for combining a time-series of three-dimensional [3D] images into a single 3D image using an encoding function, the encoding function being arranged for encoding, in voxels of the single 3D image, a change over time in respective co-located voxels of the time-series of 3D images. The method 400 further comprises, in a second step titled “GENERATING A FIRST AND SECOND 3D IMAGE”, obtaining 420 a first and second time-series of 3D images for generating, using the processor, a respective first and second 3D image. The method 400 further comprises, in a third step titled “RENDERING AN OUTPUT IMAGE”, rendering 440, from a common viewpoint, the first and the second 3D image in an output image for enabling a comparative display of the change over time of the first and the second time-series of 3D images. The method 400 may correspond to an operation of the apparatus 110. However, the method 400 may also be performed in separation from the apparatus 110.

FIG. 8 shows a computer program product 452 comprising instructions for causing a processor system to perform the method according to the present invention. The computer program product 452 may be comprised on a computer readable medium 450, for example as a series of machine readable physical marks and/or as a series of elements having different electrical, e.g., magnetic, or optical properties or values.

It is noted that, in general, the apparatus 110 may not need to use a further encoding function. Rather, the processor 120 may directly combine the first time-series of 3D images into the first 3D image and the second time-series of 3D images into the second 3D image. Thus, the processor may not need to generate intermediate 3D images. The renderer 140 may then either render a difference between the first and the second 3D image, i.e., render a single difference-based 3D image in a main viewport. Before rendering the difference-based 3D image, a mapping may be applied to the difference-based 3D image, e.g., assigning red hues to positive values and green hues to negative values. It will be appreciated that the mapping may be similar to the previously discussed image fusion processes, except for omitting the use of a further 3D image in said processes. Alternatively, the renderer 140 may render the first and the second 3D image separately, i.e., in separate first and second main viewports.

It will be appreciated that the invention also applies to computer programs, particularly computer programs on or in a carrier, adapted to put the invention into practice. The program may be in the form of a source code, an object code, a code intermediate a source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or to be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Image processing apparatus comprising:
a processor for combining a time-series of three-dimensional [3D] images into a single 3D image, using an encoding function, the encoding function being arranged for encoding, in voxels of the single 3D image, a change over time in respective co-located voxels of the time-series of 3D images;
an input for obtaining a first and second time-series of 3D images for generating, using the processor, a respective first and second 3D image; and
a renderer for rendering, from a common viewpoint, the first and the second 3D image in an output image for enabling comparative display of the change over time of the first and the second time-series of 3D images.

2. Image processing apparatus according to claim 1, wherein the processor is arranged for using a further encoding function, wherein the further encoding function differs from the encoding function for differently encoding said change over time in respective co-located voxels of the time-series of 3D images, and wherein the processor is arranged for:
generating, using the encoding function, a first intermediate 3D image from the first time-series of 3D images and a second intermediate 3D image from the second time-series of 3D images;
generating, using the further encoding function, a third intermediate 3D image from the first time-series of 3D images and a fourth intermediate 3D image from the second time-series of 3D images; and
generating the first and the second 3D image in dependence on the first intermediate 3D image, the second intermediate 3D image, the third intermediate 3D image and the fourth intermediate 3D image.

3. Image processing apparatus according to claim 2, wherein the processor is arranged for (i) generating the first 3D image as a difference between the first intermediate 3D image and the second intermediate 3D image, and (ii) generating the second 3D image as the difference between the third intermediate 3D image and the fourth intermediate 3D image.

4. Image processing apparatus according to claim 3, wherein the renderer is arranged for (i) using an image fusion process to combine the first and the second 3D image into a fused 3D image, and (ii) rendering the fused 3D image in the output image.

5. Image processing apparatus according to claim 4, wherein the image fusion process comprises (i) mapping voxel values of the first 3D image to at least one of the group of: a hue, a saturation, an opacity of the voxel values of the fused 3D image, and (ii) mapping the voxel values of the second 3D image to at least another one out of said group.

6. Image processing apparatus according to claim 3, wherein the processor is arranged for using a registration process for obtaining the first and the second 3D image as being mutually registered 3D images.

7. Image processing apparatus according to claim 6, wherein the processor is arranged for evaluating a result of the registration process for, instead of rendering the fused 3D image in the output image, rendering the first and the second 3D image in separate viewports in the output image for obtaining a side-by-side rendering of the first and the second 3D image if the registration process fails.

8. Image processing apparatus according to claim 2, wherein the processor is arranged for (i) generating the first 3D image as a combination of the first intermediate 3D image and the third intermediate 3D image, and (ii) generating the second 3D image as the combination of the second intermediate 3D image and the fourth intermediate 3D image.

9. Image processing apparatus according to claim 8, wherein the processor is arranged for using an image fusion process for said generating of the first 3D image and/or said generating of the second 3D image.

10. Image processing apparatus according to claim 8, wherein the renderer is arranged for (i) rendering the first 3D image in a first viewport in the output image, and (ii) rendering the second 3D image in a second viewport in the output image, for obtaining a side-by-side rendering of the first and the second 3D image.

11. Image processing apparatus according to claim 1, further comprising a user input for enabling a user to modify the common viewpoint of the rendering.

12. Image processing apparatus according to claim 1, wherein the first time-series of 3D images constitutes a baseline exam of a patient showing perfusion of an organ and/or tissue of the patient at a baseline date, and the second time-series of 3D images constitutes a follow-up exam of the patient showing the perfusion of the organ and/or tissue of the patient at a follow-up date for enabling the comparative display of the perfusion at the baseline date and the follow-up date.

13. Workstation or imaging apparatus comprising the image processing apparatus according to claim 1.

14. A method comprising:
using a processor for combining a time-series of three-dimensional [3D] images into a single 3D image, using an encoding function, the encoding function being arranged for encoding, in voxels of the single 3D image, a change over time in respective co-located voxels of the time-series of 3D images;
obtaining a first and second time-series of 3D images for generating, using the processor, a respective first and second 3D image; and
rendering, from a common viewpoint, the first and the second 3D image in an output image for enabling a comparative display of the change over time of the first and the second time-series of 3D images.

15. A computer program product comprising instructions for causing a processor system to perform the method according to claim 14.
